(19) United States
(12) Patent Application Publication
(10) Pub. No.: US 2003/0228453 A1
(43) Pub. Date: Dec. 11, 2003

(54) Sample strip of plastic material for moulding

(76) Inventor: Robert Petit, Savigny-sur-Orge (FR)

Correspondence Address: YOUNG & THOMPSON, 745 SOUTH 23RD STREET 2ND FLOOR, ARLINGTON, VA, 22202

(21) Appl. No.: 10/401,675

(22) Filed: Mar. 31, 2003

(30) Foreign Application Priority Data
Apr. 3, 2002 (FR) 0204134

(51) Int. Cl. B32B 7/02

(52) U.S. Cl. 428/212

(57) ABSTRACT

The sample strip is obtained by injecting the plastic material, and comprises at least one panel carrying at least two of the following evaluation elements:

a) shrinkage evaluator,

b) pinhole evaluator,

c) replication evaluation possibilities of a given pattern,

d) elements for evaluating the transparency or appearance of the material via a zone of varying thickness (50),

e) elements for evaluating mould release capacity,

f) elements for evaluating the capacity of the material to flow round an obstacle in the mould and to re-weld behind the obstacle, so as to group together on one single sample strip (1) the chief evaluation criteria of the plastic material.

### FIELD OF THE INVENTION

The invention concerns the area of plastic material evaluation tests, and more particularly the capacity of plastic materials to form moulded objects.

More especially, the invention concerns the field of plastic material injection moulding in a mould.

### PRIOR ART

A great number of testing standards exist for plastic materials. Regarding the French AFNOR standards, class number 83 080 20 alone for thermoplastic materials comprises around one hundred norms, some being more specific for particular plastic materials.

Among all these standards, AFNOR norm T58-007 is known which concerns the characterization of thermoplastic materials by injection moulding a standard object. This standard object is used to assess the injection moulding capacity of a thermoplastic material and is used in particular to evaluate shrinkage, deformation or even surface appearance for the purpose either of determining a choice between thermoplastic materials to be moulded or of comparing different batches of one same thermoplastic material.

Problems Raised

Firstly the standard object known under norm AFNOR T58-007 only allows for an initial, relatively general, selection and is therefore not suitable for all types of moulded objects or a particular type of object.

Secondly, this standard object can only lead to obtaining relatively limited information.

Finally, this standard object can only provide an initial evaluation, most often a qualitative evaluation, of the characteristics of the thermoplastic material to be tested.

The purpose of the invention is therefore, by means of a moulded sample strip, to fine-tune the relatively “rough” selection obtained when applying AFNOR norm T58-007, simultaneously to provide a large part, if not all, the information required to determine a choice of thermoplastic material for moulding, and finally whenever possible to ensure means for quantifying the characteristics to be measured or evaluated.

Said sample strip according to the invention, comprises means not only for evaluating several characteristics concerning the moulding capacity of the thermoplastic material, typically to form packaging for cosmetic products, but also means to somehow quantify these characteristics insofar as is possible.

With the invention it is therefore possible:

a) to select a plastic material without having to produce a mould of the intended end product,

b) optionally to adapt the mould of the end product, by limiting some requirements, to provide for more economical moulding of a thermoplastic material,

c) to avoid producing a mould for the end product when no thermoplastic material may necessarily exist with which to produce the end product at reasonable cost, having regard to the extent of technical requirements.

The invention generally sets out to considerably reduce the time and cost of developing and launching a new moulded product, which has major economic implications in particular in the area concerned by the invention, namely the packaging sector for cosmetic products in which the number of marketed products and their rate of renewal are very high.

### DESCRIPTION OF THE INVENTION

According to the invention, said sample strip in at least one plastic material, obtained by injecting said plastic material, or when applicable said plastic materials, into a mould by means of at least one injection duct, comprises a typically planar panel carrying at least two, and preferably at least four, of the following evaluation means a) to f):

a) means for evaluating shrinkage

b) means for evaluating pinholes,

c) means for evaluating replication possibilities of a given pattern, and/or print or decoration possibilities, typically comprising at least 2 zones or bands differing in surface roughness or grinding,

d) means for evaluating in particular the transparency or appearance of said material via a zone of varying thickness,

e) means for evaluating mould release capacity, typically by means of a wall or portion of wall, substantially vertical relative to said panel but having a given clearance angle,

f) means for evaluating the ability of said material to flow round an obstacle in said mould and to re-weld behind said obstacle, typically by means of a part that is recessed perpendicular to said panel,

so as to record and group together, typically on one single sample strip moulded in said plastic material, the chief evaluation criteria for said plastic material to determine in particular its selection to form an injection moulded product. The sample strip of the invention therefore makes it possible to solve the major problems raised, if not all.

### DESCRIPTION OF THE FIGURES

FIGS. 1a to 8c relate to a sample strip 1 of the invention, in two parts 8A and 8B.

FIGS. 1a to 4c concern a first part or lid 8B and FIGS. 5a to 8c concern a second part or bottom part 8A.

FIG. 1a is a perspective view of the so-called outer surface of said first part, FIG. 1b being a perspective view of the so-called inner surface of said first part.

FIG. 2a is an underside view of said outer surface of said first part, and FIG. 2b is an overhead view of said inner surface of said first part.

FIGS. 3a and 3b are section views A-A and B-B respectively relative to FIG. 2b.

FIGS. 4a to 4c are side views of said first part; FIG. 4a corresponds to the shorter side of said first part—on the left in FIGS. 2a and 2b, FIG. 4b corresponds to the longer side—at the front or rear in FIGS. 2a and 2b, and FIG. 4c to the curved end on the right in FIGS. 2a and 2b.

Similarly, FIG. 5a is a perspective view of the so-called outer surface of said second part, FIG. 5b being a perspective view of the so-called inner surface of said first part.

FIG. 6a is an underside view of the said so-called outer surface of said second part, FIG. 6b being an overhead view of the so-called inner surface of said first part.

FIGS. 7a and 7b are section views A-A and B-B respectively relative to FIGS. 6b.

FIGS. 8a to 8c are side views of said second part: FIG. 8a corresponds to the shorter side of said second part—on the left in FIGS. 6a and 6b, FIG. 8b to the longer side—at the front or rear in FIGS. 6a and 6b, and FIG. 8c corresponds to the curved end —on the right in FIGS. 6a and 6b.

### DETAILED DESCRIPTION OF THE INVENTION

The evaluation means 2, 3, 4, 5, 6, 7 previously described under a) to f) call for the following remarks.

The shrinkage in means 2 under a) corresponds to the difference between the nominal dimensions of the item in the mould, and therefore in general to a relatively high temperature, and the final dimensions of the item once it has been released from the mould at room temperature.

The pinholes in means 3) under b) correspond to cavities formed during moulding. These are defects which typically occur at the junction of “T” partitions.

In means 4) under c) and in respect of grinding or roughness, a granular scale called the CH or “Charmille” scale may be used that is known to persons skilled in the art, after the name of a Swiss company which manufactures electro-erosion machines, this CH scale being used as a reference for increasingly finer contours and hollows ranging from the highest values i.e. 32, to the lowest, i.e. 14, so as to assess replication capacity and hence the replication sensitivity of each thermoplastic material.

In means 5) under d) the zone of variable thickness 50 is used in particular:

to assess colours on a curved part relative to planar parts and to detect colour differences, optionally relative to a standard, since in the area of cosmetic packaging a given colour may be associated with a trademark image,

to evaluate transparency in relation to thickness,

to evaluate supra-moulding possibilities for different materials, whether flexible or rigid, verifying the cohesion between these materials.

According to means 6) under e) if the products to be moulded comprise vertical or slightly oblique parts or walls, the sample strip comprises at least one portion of wall 60 that is vertical in relation to said panel and forms a clearance angle so as to evaluate the mould release capacity of the said material. It is therefore possible to have several portions of wall 60, each one having a different clearance angle: a clearance angle of 2°, 3° and 4° for example.

It is also possible for each of them to have several grades of grind or roughness.

The surface condition is examined of these substantially vertical portions of wall 60 having varying clearance angles, their replication quality is assessed and their mould release capacity is therefore determined according to clearance angle.

According to means 7 under f) , and having regard to the geometry of the products to be moulded, the sample strip 1 comprises at least one part 12 that is recessed perpendicular to said panel, intended to evaluate the ability of said material to flow round an obstacle in the mould and to re-weld behind that obstacle. By-passing an obstacle disturbs the flow of molten plastic material and sets up weld lines behind the obstacle of greater or lesser visibility or length depending upon the material and the pigments used. For pearl colours for example, depending upon flow disturbance, orientation of the pigment particles occurs which modifies appearance even if the weld lines with material cohesion become fusion lines.

The sample strip 1 of the invention may carry the entirety of the evaluation means a) to f) insofar as, in the area of moulded products under consideration, it is generally important for all these evaluation means to be used.

According to the invention, said sample strip 1 may be formed by means of a mould typically comprising 1 to 4 plastic material injection ducts.

Therefore, said sample strip 1 may be formed using a mould comprising 3 injection ducts, each having a different inner diameter with typical inner diameters of 0.6 mm, 1 mm and 1.5 mm.

This makes it possible to obtain various types of flow of molten plastic material and therefore to choose only the number of ducts that is strictly necessary in relation to the results obtained with said evaluation means 2, 3, 4, 5, 6, and 7, thereby limiting mould complexity and cost without significantly reducing the final quality of the moulded product.

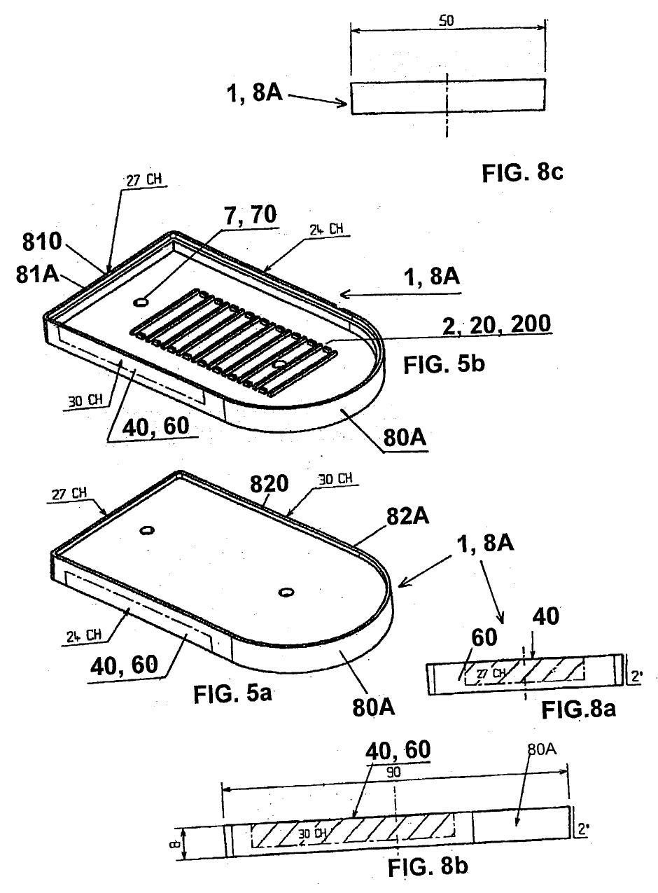

According to the invention, and as illustrated in FIGS. 5b, 6b and 7a, said shrinkage evaluation means 2 may be a shrinkage measurement indicator typically in the form of a graduated scale 20 with parallel increments at regular distances, each increment being formed by a ridge 200 or groove.

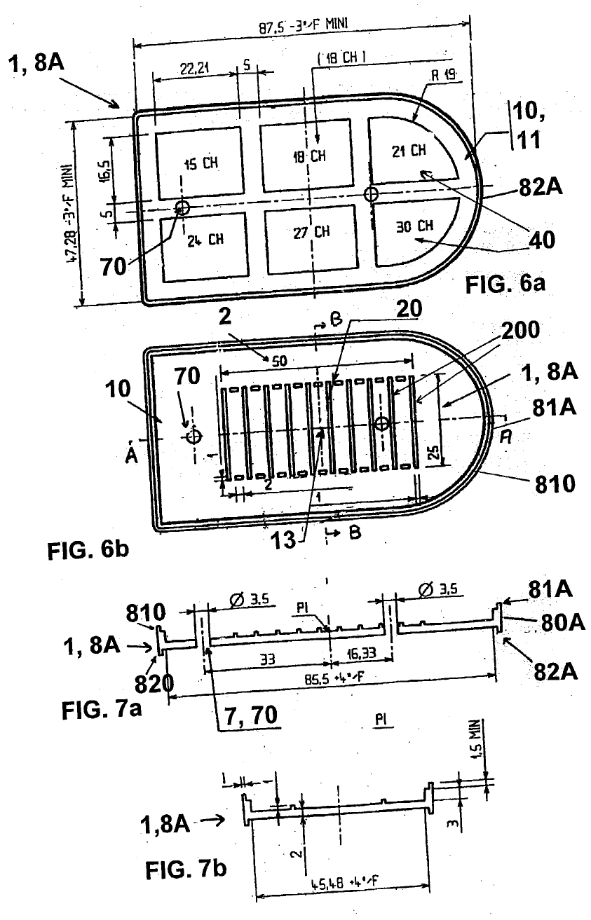

As shown in FIG. 6b, the nominal distance between the end ridges 200 is 50 mm, so that the rate of shrinkage is obtained directly by multiplying by 2 the distance measured (in mm) between end ridges. It is optionally advantageous to have a dual scale, one side having end ridges 50 mm apart, and another side having end ridges 50.8 mm apart, i.e. 2 inches, should measurements be made in inches to give said sample strip 1 potential use anywhere in the world.

Means 3) under b), for measuring pinholes may be formed by a tongue comprising at least two portions of different thickness.

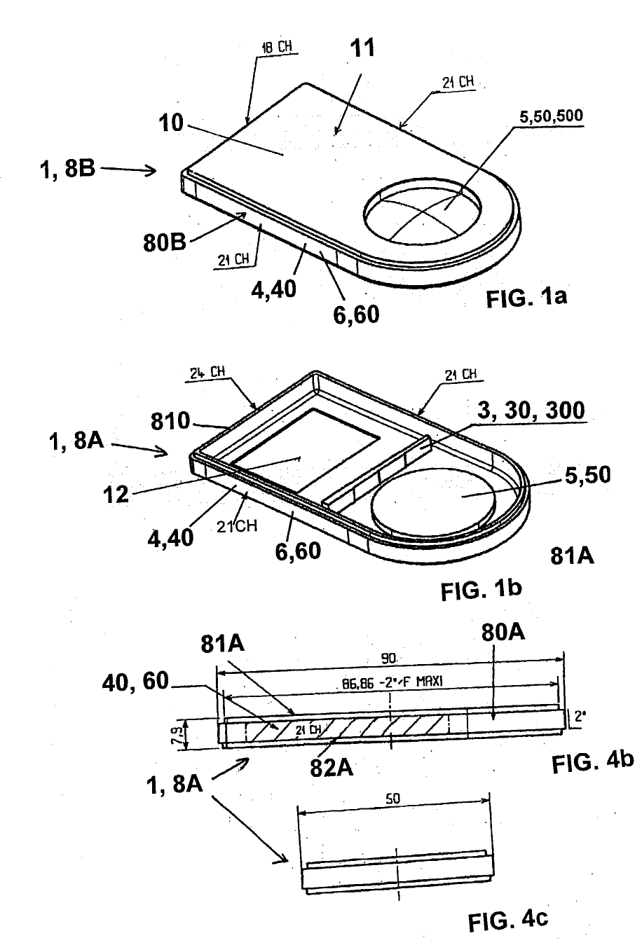

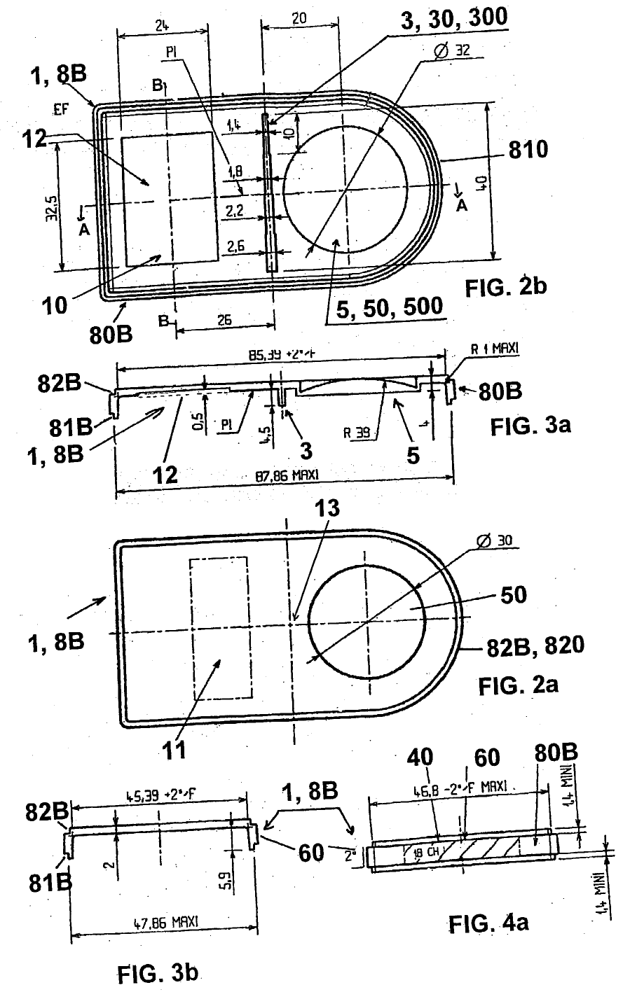

As illustrated in FIGS. 1b and 2b, said tongue may be a tongue 30 perpendicular to said panel 10 comprising 3 or 4 portions 300 of different thickness having a staircase profile, each portion 300 corresponding to one step. The tongue 30 in FIGS. 1b and 2b comprises 4 portions 300.

According to the invention, said sample strip may comprise an attached part, said sample strip 1 typically having been supra-moulded over said attached part placed in said mould, or optionally said attached part having been supra-moulded over said sample strip in a second mould.

Typically, said sample strip may be substantially planar with a size typically ranging from 9 cm×12 cm, a so-called pocket format, to approximately 21 cm×29 cm, a so-called A4 page format, said sample strip 1 optionally comprising means with which to make said sample strip integral with a carrier or another sample strip in order to form a collection of sample strips 1, said means possibly being formed by said plastic material or by another material, a ring for example or metal wire possibly forming said attached part.

According to one modality of the invention, said sample strip 1 may comprise two parts 8A and 8B, intended to cooperate so as to form typically either a container with substantially planar surfaces, said parts 8A, 8B typically comprising side walls 80A, 80B whose outer edges 82A, 82B have a staircase profile 820 so that it is possible to evaluate the stacking of said parts 8A, 8B, or to form two flaps associated or articulated with one another in the manner of two pages of a book.

FIGS. 1a to 8c illustrate the case in which the two parts 8A, 8B cooperate like two parts of a box forming a container with substantially planar surfaces.

Preferably, as illustrated for example in FIGS. 8a and 8b, each of said parts 8A, 8B may comprise at least one of said evaluation means 2, 3, 4, 5, 6, 7 under a) to f).

According to the invention, and as illustrated in the figures, at least one of said parts 8A, 8B may comprise a side wall 80A, 80B with an inner edge 81A, 81B having a staircase profile 810, said inner edges 81A, 81B typically cooperating such as to form a container and to test the clearance between said parts 8A, 8B.

Preferably, at least one of said side walls 80A, 80B may act as carrier for, or comprise, at least one of said means 2, 3, 4, 5, 6, 7.

Therefore, as illustrated in FIGS. 8a and 8b, said side wall 80A, 80B may comprise at least one portion of wall 60 having a determined clearance angle, and/or at least one zone or band 40 of determined roughness, so as to evaluate and, preferably, to quantify mould release capacity.

According to one variant of the invention, said parts 8A, 8B may comprise cooperation means and optionally a flexible hinge making it possible to form a container able to be closed by a lid, one of said parts forming said container, the other of said parts forming said lid.

According to another variant of the invention, said parts 8A, 8B may cooperate via male and female parts which may optionally click fit together.

Typically said plastic material may be mass-coloured. In this case the invention is particularly advantageous since, through means 5 under d) in particular it is possible to obtain an immediate idea of the visual rendering given by a given plastic material and given pigment.

In this manner, it is possible for example to group together a series of sample strips 1 corresponding to one same plastic material but with pigments differing in type and/or content, or even to group together a series of sample strips 1 coloured with the same content of dye agent but on different plastic materials.

According to the invention, said panel 10 may comprise one or more bands 11 able to receive at least one surface treatment and/ or at least one decoration or print, so as to test the compatibility of said plastic material with said surface treatment and/or said decoration or print.

In the area of cosmetic packaging in particular, the final appearance is essential so that it is important when developing a new moulded product to have an idea of this final appearance as soon as possible so as to avoid losing much time and money by following possible routes which prove to be dead ends.

As illustrated in FIGS. 1b, 2b and 3a, said sample strip 1 may comprise a recessed part 12 forming a housing able to house a mirror so as to test the resistance of said mirror and/or the compatibility between the material of said mirror, typically glass, metal or a plastic material, and said plastic material.

Typically the sample strips of the invention have a form factor of at least 5, and preferably of at least 10.

A further subject of the invention is an injection mould intended to be used to produce the sample strip 1 of the invention. Said mould is not shown in the figures since the moulding of the items forming parts 8A, 8B shown in the appended figures are items for which a two-part mould is suitable for their production i.e. a conventional design for persons skilled in the art.

A further purpose of the invention is the use of said sample strip 1 of the invention as means to promote said plastic material.

Numerous plastic material manufacturers or processors may benefit from using the sample strips 1 of the invention, in particular to visualize and compare the above-mentioned characteristics, for example multiple grades of one same polymer family.

Indeed the invention finds particular interest whenever it is necessary to evaluate special characteristics or properties, properties over and above the standard characteristics of plastic materials, for example mechanical characteristics defined by a simple numerical value.

A further subject of the invention is the use of said sample strip 1 as a selection means to select a plastic material for moulding, determined either in respect of the material alone or optionally relative to a surface treatment and/or subsequent decoration or print, for the purpose in particular of manufacturing packaging for cosmetic products typically cases, bottles, applicators or tubes of lipstick or mascara.

Finally another subject of the invention is a collection of sample strips 1, said sample strips 1 being joined, at least temporarily, typically to a binder type support for example or a stacking type support, or joined to one another to form a concertina-type fold.

Having regard to the possible uses of said strips, it is advantageous for them to be grouped, whether to compare different plastic materials according to type and/or grade or to compare different modalities of one same plastic material, which modalities may for example be based on different mass treatments (mass colouring) or surface treatments (print, surface treatment).

### EXAMPLE OF EMBODIMENT

FIGS. 1a to 8c correspond to a sample strip 1 according to the invention carrying the entirety of the evaluation means under consideration 2, 3, 4, 5, 6, 7.

This sample strip 1 comprises two parts: one part forming a bottom part 8A and a part forming a lid 8B.

However it is also possible to consider each part 8A, 8B as a sample strip carrying a more limited number of evaluation means.

Hence bottom part 8A carries some evaluation means 2, 4, 6, 7, 11 whereas the lid 8B carries means 3, 4, 5, 6, 11, 12 some of these means being different from those of the bottom part whereas others 4, 6 may be common to the lid and to the bottom part.

Lid 8B is shown in FIGS. 1a to 4c while the bottom part 8A is shown in FIGS. 5a to 8C.

FIG. 1a is a side perspective view of the top of the lid 8B forming a planar panel 10 and of a side wall 80B.

The planar panel 10 forms a test zone 11 for printing, decoration or surface treatment, including metallization. This panel 10 may optionally, similarly to the illustration in FIG. 6a, comprise six zones 40 with different CH levels of roughness or grind: 15CH, 18CH, 21CH, 24CH, 27CH and 30 CH so as to evaluate replication possibilities 4 on a flat surface.

The side wall 80B forms a sequence of wall portions forming areas of given grind or roughness 40, in particular 18CH and 21CH roughness/or having a given clearance angle 60.

FIG. 1a shows the raised part of the dome 500 that is recessed and offset relative to the plane of panel 10 and forms a zone of variable thickness 50 providing an example of evaluation means 5 to assess the influence of the thickness of the thermoplastic material.

FIG. 1b is a view similar to that in FIG. 1a, a side perspective view of the underside of the lid 8B.

This underside view makes it possible, in addition to the elements visible in FIG. 1a, to see a recessed part 12 able to house a mirror, and the means for evaluating pinholes 3 which forms a ridge or cross tongue 30 formed of four portions of increasing thickness.

As regards the underside of the dome 500, this forms a planar area which may optionally carry a surface grind area 40 or test zone 11.

FIG. 2a is an overhead view of the lid 8B whereas FIG. 2b is an underside view.

FIG. 3a is a section view along the plane A-A of FIG. 2b showing in particular a section view of the dome 500, while FIG. 3b is a section view along the plane B-B of FIG. 2b, these planes A-A and B-B being perpendicular to the panel 10.

FIGS. 3a and 3b show the form of the outer edge 82B and inner edge 81B having a staircase profile 810, 820.

FIGS. 4a to 4c are side views: FIG. 4a corresponds to the straight shorter side, FIG. 4b corresponds to the longer sides, and FIG. 4c corresponds to the shorter semicircular side.

FIG. 5a is a side perspective view of the underside of bottom part 8A forming a planar panel 10 and of a side wall 80A, while FIG. 6a is an underside view.

The planar panel 10 forms a test zone 11 for printing, decoration or surface treatment, including metallization. This panel 10 as illustrated in FIG. 6a comprises six zones 40 with different levels of CH grind or roughness: 15CH, 18CH, 21CH, 24CH, 27CH and 30CH so as to evaluate replication possibilities 4 on a flat surface.

The planar panel 10 comprises two recessed parts 70 intended to form the means 7 for observing how the thermoplastic material re-welds after by-passing an obstacle in a mould.

The side wall 80A forms a sequence of wall portions forming areas of given grind or roughness 40, in particular roughness of 24CH, 27CH and 30CH and/or having a given clearance angle 60.

FIG. 5b is a similar view to FIG. 5a in side perspective of the top side of bottom part 81 while FIG. 6b is an overhead view.

With this overhead view it is possible, in addition to the elements visible in FIG. 5a, to see in particular means 2 for evaluating shrinkage, in the form of a succession of parallel ridges 200 which form a scale 50 with ten bars 50 mm long, each ridge 200 forming a bar 25 mm long.

FIGS. 7a and 7b are section views of the bottom part 8A along planes A-A and B-B of FIG. 6b, these planes being perpendicular to the panel 10.

FIGS. 8a to 8c are side views of the bottom part 8A; FIG. 8a corresponds to the shorter straight side, FIG. 8b to the longer sides, and FIG. 8c corresponds to the shorter semicircular side.

In one variant of embodiment, the inner edge 81B of the lid and the inner edge 81A of the bottom part cooperate via a click fit system so that the assembly formed by the bottom part 8A and the lid 8B is a container easy to open manually and able to contain any desired item which may optionally be a leaflet giving additional information for example on the thermoplastic material used to form said sample strip 1.

For each part 8A, 8B a corresponding two-piece mould was manufactured.

Each mould comprised 3 injection ducts A, B and C to insert the thermoplastic material in the mould:

either via a single duct: either duct A, duct B or duct C

or via two ducts: either ducts A+B, or ducts A+C or ducts B+C

or via the three ducts at the same time.

Examination of the corresponding sample strips 1 makes it possible to determine the optimum number and position of the injection ducts. These injection ducts leads to injection zones 13 on the sample strips. See for example FIGS. 2a and 6b showing a single central injection zone 13.

It is important to note that the dimensions of the sample strip 1 for tests were close to or in the same order of magnitude as those for actual products to be manufactured, typically packaging for cosmetic products, powder compacts for example.

The numerous tests conducted by the applicant on all kinds of plastic materials comprising a wide variety of pigments showed that the conclusions drawn from the examination of each sample strip 1 indeed made it possible, in reliable manner, to select the products and operating conditions on the sample strip 1 without having to conduct tests on a specific mould for a product to be manufactured.

Advantages of the Invention

With the invention it is effectively possible to gain time in developing new products produced by injection moulding a thermoplastic material.

It is also limits the cost of test equipment or the risk of final failure, since with the sample strips it becomes possible to reject any solution which does not meet the final end requirements.

The invention also provides for more precise dialogue between manufacturers or suppliers of thermoplastic materials and users or manufacturers of injection moulded parts or items, through its possible use as part of product specifications for example.

The invention sets out to characterize properties of practical importance which are not to be found in tables or documents, the latter determining properties by a simple numerical value such as yield resistance.

In addition, the sample strip of the invention, unlike the standard product according to AFNOR norm T58-007, is essentially bi-dimensional, having a form factor given by the ratio “length or greater dimension/thickness”, typically greater than 10, it is relatively compact and is therefore easy to store and possibly classify much like the page of a document.

Finally the invention may facilitate the dialogue between manufacturers of moulded products and customers, the sample strip possibly entering into specifications or approval to launch industrial production.

To conclude, in the area of moulded plastic products the present invention can benefit any and all players involved in the entire process from raw material supply to end product.

List of Reference Numbers

Sample strip 1

Typically planar panel 10

Test zone: surface treatment, print 11

Recessed part able to house a mirror 12

Injection inlet zone for injection duct 13

Shrinkage evaluation means 2

Graduated scale 20

Ridge or groove 200

Pinhole evaluation means 3

Tongue of graduated thickness 30

Portion of given thickness 300

Replication possibility evaluation means 4

Zone or band of given CH grind or roughness 40

Means for evaluating influence of thickness 5

Zone of variable thickness 50

Dome 500

Means for evaluating mould release capacity 6

Portion of wall with a clearance angle ±0° 60

Means for evaluating ability to bypass obstacle 7

Recessed part 70

Parts which cooperate and form 18A, 8B

Part forming a bottom part 8A

Part forming a lid 8B

Side wall 80A, 80B

Inner edges 81A, 81B

Staircase profile 810

Outer edges 82A, 82B

Staircase profile 820

1. Sample strip (1) in at least one plastic material, obtained by injecting said plastic material, or said plastic materials when applicable, into a mould by means of at least one injection duct, comprising at least one typically planar panel (10) carrying at least two and preferably at least four of the following evaluation means (2, 3, 4, 5, 6, 7):
a) shrinkage evaluation means (2)
b) pinhole evaluation means (3)
c) means (4) for evaluating replication possibilities of a given pattern, and/or printing or decoration possibilities, typically comprising at least 2 zones or bands (40) differing in surface grind or roughness,
d) means (5) for evaluating the transparency or appearance of said material via a zone of varying thickness (50),
e) means (6) for evaluating mould release capacity, typically using a wall or portion of wall (60), substantially vertical relative to said panel (10), having a given clearance angle,
f) means (7) for evaluating the capacity of said material to flow round an obstacle in said mould and to re-weld behind said obstacle, typically via a part (70) recessed perpendicular to said panel,
so as to record and group together, typically on one single sample strip (1) moulded in said plastic material, the chief evaluation criteria of said plastic material for the purpose in particular of its selection for forming an injection moulded product.

2. Sample strip according to claim 1, formed by means of a mould typically comprising 1 to 4 injection ducts for plastic material.

3. Sample strip according to claim 2, formed by means of a mould comprising 3 injection ducts, each having a different inner diameter, with typical inner diameters of 0.6 mm, 1 mm and 1.5 mm.

4. Sample strip according to any of claims 1 to 3, in which said shrinkage evaluation means (2) is an indicator of shrinkage measurement typically in the form of a graduated scale (20) with parallel increments at regular intervals, each increment being formed by a ridge (200) or a groove.

5. Sample strip according to any of claims 1 to 4, in which said pinhole evaluation means (3) is formed by a tongue comprising at least two portions of different thickness.

6. Sample strip according to claim 5 in which said tongue is a tongue (30) perpendicular to said panel (10) comprising 3 or 4 portions (300) of different thickness having a staircase profile, each portion (300) corresponding to a step.

7. Sample strip according to any of claims 1 to 6 comprising an attached part, said sample strip (1) having been typically supra-moulded over said attached part placed in said mould, or optionally, said attached part having been supra-moulded over said sample strip in a second mould.

8. Sample strip according any of claims 1 to 7, substantially planar with a typical size ranging from a so-called pocket format of 9 cm×12 cm to a so-called A4 page format of approximately 21 cm×29 cm, said sample strip (1) optionally comprising means with which to make said sample strip integral with a carrier or another sample strip to form a collection of sample strips (1), said means possibly being formed by said plastic material or another material, for example a ring or metal wire possibly forming said attached part.

9. Sample strip according to any of claims 1 to 7 comprising two parts (8A, 8B) intended to cooperate and typically form either a container with substantially planar surfaces, said parts (8A, 8B) typically comprising side walls (80A, 80B) with outer edges (82A, 82B) and staircase profile (820) intended to evaluate the stacking of said parts (8A, 8B), or to form two flaps associated or articulated with one another in the manner of two pages of a book.

10. Sample strip according to claim 9 in which each of said parts (8A, 8B) comprises at least one of said evaluation means a) to f).

11. Sample strip according to either of claims 9 and 10, in which said side walls (80A, 80B) comprise inner edges (81A, 81B), typically having a staircase profile (810), said inner edges (81A, 81B) cooperating typically so as to form a container and to test in particular the clearance between said parts (8a, 8B).

12. Sample strip according to claim 11, in which at least one of said side walls (80A, 80B) acts as support for, or comprises, at least one of said means (2, 3, 4, 5, 6, 7).

13. Sample strip according to claim 12 in which said side wall (80A, 80B) comprises at least one portion of wall (60) having a given clearance angle, and/or at least one zone or band (40) of determined roughness, so as to evaluate and, preferably, to quantify mould release capacity.

14. Sample strip according to any of claims 9 to 13, in which said parts (8A, 8B) comprise cooperating means, and optionally a flexible hinge, with which to form a container able to be closed by a lid, one of said parts forming said container, the other of said parts forming said lid.

15. Sample strip according to any of claims 9 to 13, in which said parts (8A, 8B) cooperate via male and female elements which may optionally click fit together.

16. Sample strip according to any of claims 1 to 15, in which said plastic material is mass-coloured.

17. Sample strip according to any of claims 1 to 16, in which said panel (10)comprises zones (11) able to receive at least one surface treatment and/or at least one decoration or print, so as to test the compatibility of said plastic material with said surface treatment and/or said decoration or print.

18. Sample strip according to any of claims 1 to 17, comprising a recessed part 12 forming a housing able to house a mirror so as to test the resistance of said mirror and/or the compatibility between the material of said mirror, typically glass, metal or a plastic material, and said plastic material.

19. Sample strip according to any of claims 1 to 18, having a form factor of at least 5 and preferably of at least 10.

20. Use of said sample strip (1) according to any of claims 1 to 19 as means for promoting said plastic material.

21. Use of said sample strip (1) according to any of claims 1 to 19 as means for selecting a plastic material determined either in respect of the material alone or optionally relative to a surface treatment and/or a subsequent decoration or print, for the purpose in particular of manufacturing packaging for cosmetic products, typically, cases, bottles, applicators or lipstick or mascara tubes.

22. Collection of sample strips (1) according to any of claims 1 to 19, said sample strips (1) being joined, at least temporarily, typically to a binder type support for example or a stacking type support, or joined to one another to form a concertina-type fold.
